(19) United States
(12) Patent Application Publication
(10) Pub. No.: US 2016/0180478 A1
(43) Pub. Date: Jun. 23, 2016

(54) Real Property-Addressed Electronic Messaging

(71) Applicant: HomeAhead LLC, Bellaire, TX (US)

(72) Inventor: David Cunningham, Bellaire, TX (US)

(21) Appl. No.: 14/978,952

(22) Filed: Dec. 22, 2015

Related U.S. Application Data
(60) Provisional application No. 62/096,141, filed on Dec. 23, 2014.
(60) Provisional application No. 62/169,284, filed on Jun. 1, 2015.

(51) Int. Cl. G06Q 50/16; H04N 1/00; G06Q 30/06

(52) U.S. Cl. CPC G06Q 50/167; G06Q 30/0623; H04N 1/00

(57) ABSTRACT

Provided is process including receiving a request for real estate in a geographic area specified by the request from a first user; retrieving responsive real estate from a real estate data repository; sending the responsive real estate to the first user; receiving, from the first user, a message to a given property among the responsive real estate; storing the message in a message data repository in a record corresponding to the given property; verifying that a second user is an owner of the given property; receiving, from the second user, a request for messages to the given property; retrieving the message from the first user from the message data repository; and sending the message from the first user to the second user.

### CROSS-REFERENCE TO RELATED APPLICATIONS

The present application is a non-provisional of, and thus claims the benefit of, U.S. Provisional Patent Application 62/096,141, filed 23 Dec. 2014, titled Real Property-Addressed Electronic Messaging, and U.S. Provisional Patent Application 62/169,284, filed 1 Jun. 2015, titled CROWD SOURCING REAL ESTATE VALUATION ESTIMATES, the contents of each of which are hereby incorporated by reference.

### BACKGROUND

1. Field

The present invention relates generally to distributed computing applications and, more specifically, to messaging systems in which real properties define the addressing namespace of the messaging system.

2. Description of the Related Art

Real estate websites generally provide, via the World-Wide Web, information about real property, such as residential properties and commercial properties. Often these services host searchable records about various properties for sale, such as residential homes for sale in a user-specified zip code. In many cases, the websites include information for users to contact listing agents to make offers on houses and advertisements related to the geographic area in which the user is searching.

Existing real estate websites suffer a number of deficiencies. For instance, many real estate websites only allow buyers to search on listed properties, and buyers cannot search information on unlisted properties. Buyers, in some systems, can only learn property information through agents, but those buyers cannot communicate with sellers or homeowners directly. Further, many existing real estate websites have no marketplace for agents to compete to represent clients (buyers and sellers). Home owners in many existing systems have no place to see levels of interest in their property, or to find the pool of buyers who have interest.

One reason for some of these issues with conventional systems is that existing messaging systems are not suitable for allowing buyers to communicate with homeowners directly. Often the buyer only knows the mailing address or identity (e.g., unique location) of the property, not of the owner, so contacting the owner is difficult. And to the extent users might self-identify to a messaging system as the owner of a given property, verification of ownership is often lax, e.g., being based solely on knowing the owner's name and the property address, leaving room for misrepresentations of ownership and abusive use of such messaging systems. Further, existing messaging systems do not serve the interests of other stakeholders in the home buying process, such as local multiple listing services, realtors, mortgage brokers, home inspectors, movers, and home renovation specialists.

### SUMMARY

The following is a non-exhaustive listing of some aspects of the present techniques. These and other aspects are described in the following disclosure.

Some aspects include a process including receiving a request for real estate in a geographic area specified by the request from a first user; retrieving responsive real estate from a real estate data repository; sending the responsive real estate to the first user; receiving, from the first user, a message to a given property among the responsive real estate; storing the message in a message data repository in a record corresponding to the given property; verifying that a second user is an owner of the given property; receiving, from the second user, a request for messages to the given property; retrieving the message from the first user from the message data repository; and sending the message from the first user to the second user.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 shows an example of a property-messaging system in accordance with some embodiments of the present techniques;

FIG. 2 shows an example of a process for messaging real property owners in accordance with some embodiments of the present techniques;

FIG. 3 shows an example of a computer system by which the above processes and systems may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the real estate website field. Indeed, the inventors wish to emphasize the difficulty of recognizing those problems that are nascent and will become much more apparent in the future should trends in real estate continue as the inventors expect. Further, because multiple problems are addressed, it should be understood that some embodiments are problem-specific and not all embodiments address every problem with traditional systems described herein or provide every benefit described herein. That said, improvements that solve various permutations of these problems are described below.

Some embodiments provide a technology for creating a community of verified homeowners and homebuyers, which can be leveraged by the owners and buyers for activities including various permutations of the following: 1) Indicating interests in a property or transaction, even if in the future; 2) Finding buying opportunities not on Multiple Listing Service (MLS) listings (e.g., providing a pre-market marketplace); 3) If desired, conducting transactions online (e.g., sales, rentals) with the assistance of a realtor or directly; and 4) Letting agents compete to be a listing or buyer's agent.

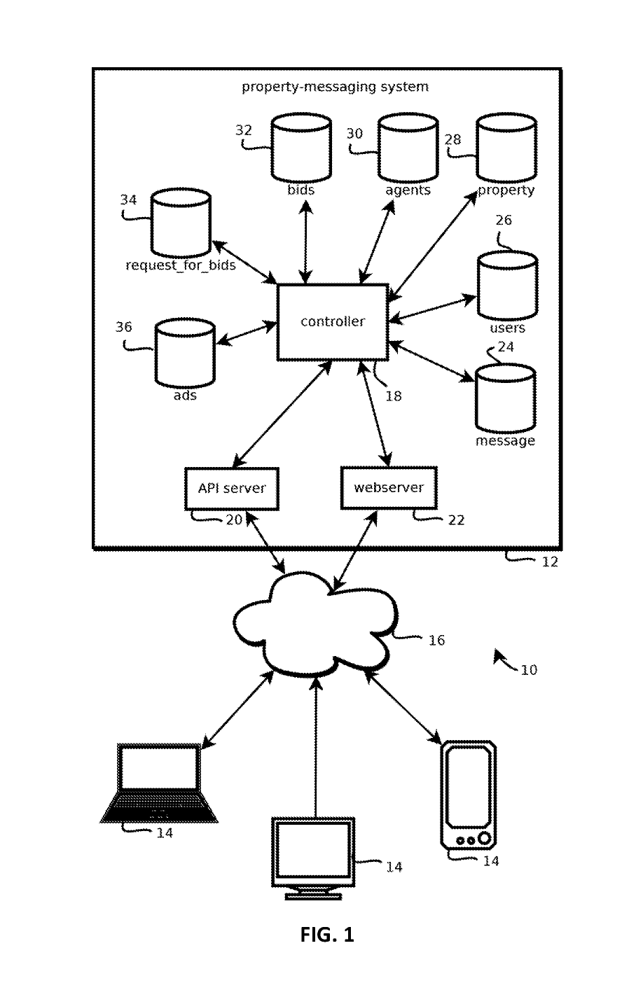

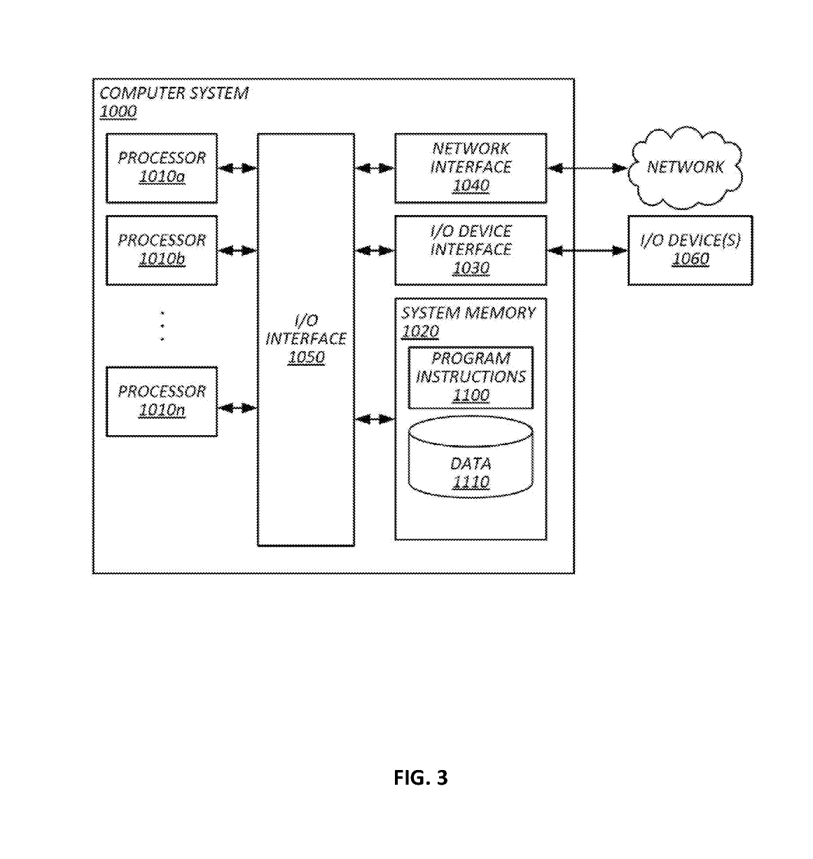

FIG. 1 shows an example of a computing environment 10 that, in some embodiments, address various subsets, and in some cases all, of the problems with traditional real estate websites discussed above. In this example, the computing environment includes a property-messaging system 12 connected to three illustrated user computing devices 14 via the Internet 16. Each of these components may include various numbers of computing systems, each of which may be like those described below with reference to FIG. 3. In some embodiments, the property-messaging system may include such computers executing various servers, and in the case of the three user devices, such computers may be obtained by users in the form of laptops, desktops, tablets, smart phones, wearables, set-top boxes, in-dash automobile computers, and the like.

In FIG. 1, only three user devices are shown by way of example, but in commercial embodiments, the number of user devices is expected to be relatively large, for example, numbering in the millions or tens of millions (e.g., corresponding to more than 1,000, 10,000, 100,000, or 1,000,000 concurrent sessions). The user base is expected to be geographically distributed, for example, over the entire United States, over the continent of North America, or around the world. As such, some embodiments may be designed to mitigate latency-related issues that tend to arrive at such scales, for instance, by providing responses to requests within less than 500-ms by, for example, by using content delivery networks, geographic replicated servers, content addressable data structures; and indexing, replication, and pre-sorting of records.

In some embodiments, the property-messaging system 12 may allow a buyer, operating one of the user devices 14 shown, to communicate with a property owner, operating another of the user devices 14. In some cases, the property owner has not yet listed their property as being for sale, and in some cases, the property owner has not yet registered with the property-messaging system, before the buyer submits a message for the property. Thus, in some use cases, buyers can leave messages for property owners, such as expressions of interest in purchasing a given property, without having to wait for those property owners to identify themselves or register with the property messaging system. In this example, property owners can later register with the property-messaging system and receive messages about their property approximately immediately, such as messages having been sent over the previous several months. That said, messages may also be sent in some embodiments to property owners who have already registered. Some embodiments of the property-messaging system can automatically print and send a postcard, or other parcel, such as a letter, addressed to the property owner (even if not registered or verified by the system) to let them know that a message is waiting for them, or the buyer can request such a process, which can include an extra charge to the buyer.

In some cases, a verification process is used to confirm that those registering as the owner of a given property (e.g., claiming the property in the system 12) are likely to be the owner of the property to avoid various forms of malfeasance, such as antagonistic neighbors registering as the owner of a neighboring property and responding in a way calculated to messages to drive away buyers. In one example of a verification process, some embodiments of the property-messaging system 12 may print a postcard, or other parcel, such as a letter, addressed to a mailing address of a property to be verified and including a unique and difficult to guess code, along with instructions to log into the property-messaging system and enter the code to verify ownership. Upon receiving the code, the system 12 may send an interface (e.g., such as a webform sent to device 14) by which the user registers and can begin receiving messages for that property. Thus, in some cases, receiving mail addressed to a given property may be used as a proxy for ownership, or at least control of the property, sufficient to warrant access to the messages for that property. In some cases, additional checks may be used, such as requesting the owner to send in a photocopy of a bill, reconciling ownership with the county land office, or sending a person to walk door-to-door and verify ownership. Upon detecting an inconsistency, some embodiments may deny access to the messages until the inconsistency is reconciled.

The property-messaging system 12 may be used in a variety of different capacities depending upon the role of the user. In one example, a buyer may navigate to the property-messaging system 12, for example, with a web browser or by launching a special-purpose native application on a mobile device 14, and enter a search query for properties, such as for properties in a specified geographic area (like a zip code) and satisfying certain other criteria, such as single-family homes, properties likely worth less than a certain amount of money, or the like. In some cases, through requests sent from device 14 to system 12 over the Internet 16, the buyer may specify that they are only interested in seeing homes that are listed on the local multiple listing service (MLS); the buyer may specify that they are interested in seeing only homes that are not yet listed; or the buyer may specify both homes that have been listed and homes that have not. The property-messaging system 12 may query a property data repository 28 and send the buyer's user device 14 a list of responsive properties and instructions to display those properties. The buyer may then select one of the listed properties, for example, by clicking on an icon on a map or selecting a given uniform resource locator (URL), indicating to the property-messaging system the buyer's interest in that property. In response, the property-messaging system 12 may send the buyer information about the property, such as whether it is for sale, whether the property has been claimed by an owner to whom they can communicate, whether the properties is for rent, and various other facts about the property, e.g., the size, estimated value, taxes, and the like. The user may, in some cases, be afforded the opportunity to designate the property as a favorite, such that they can later readily find the property.

In some cases, if the property is determined to be claimed by a verified owner by system 12, the buyer may be presented with an interface (e.g., their device 14 may be sent instructions to display a graphical user interface by system 12) by which the buyer may send a message to the property owner. Or in some cases, the buyer may be presented with the option to send such a message without regard to whether the property is claimed by a verified owner. In some cases, some embodiments may determine whether a property is listed under a real estate agent, in which case the buyer's communication may be directed to the agent, rather than to the owner, or to both. In some cases, buyers may choose to register with the property-messaging system, thereby creating a more expansive user profile for things like storing favorites. Some embodiments are agent friendly and will let an agent act on behalf of an owner or buyer. For example, an owner's listing agent can see buyers who have stated an interest in the property and communicate with them on behalf of the owner, in some embodiments.

Various kinds of messages may be sent between devices 14 via system 12, including prose composed by the buyer, such as in the format of an email, including a subject and a body, or some embodiments may include an interface (sent by system 12 to device 14) by which the buyer selects among pre-composed options to communicate (selected messages being returned by device 14 to system 12). Examples of such options include a list of messages, like “I am interested in buying your home,” “I am interested in renting your home,” “have you been happy living on this street?,” “any complaints with your homebuilder you are willing to share?,” and the like. In some cases, multiple lists of such options may be presented, so that the buyer can compose a message by selecting among each list. Another list may include attributes of the buyer, such as checkboxes that the buyer can select, like whether the buyer is a cash buyer, whether the buyer is prequalified for a sufficiently large mortgage, whether the buyer's offer would be contingent on the sale of another house, and the like. In some cases, the buyer may be presented with a field by which the buyer enters an amount they would be willing to pay for the house. Each piece of information entered by the buyer, in some cases, may be packaged together into a date stamped message associated with the buyer and with a unique identifier of the property at issue by system 12. In some cases, buyer attributes are captured as part of a separate workflow from messaging. For instance, during registration, buyers may be sent an interface by which they enter the various buyer attributes described herein. In some cases, potential sellers may be given access to some or all of these profiles, e.g., via a hyperlink associated with a message, to evaluate buyers, e.g., determine whether they are pre-qualified. Similarly, in some cases, owners may claim a property and edit a profile of the property, e.g., to correct errors in size, room count, school district, or the like. Also, in some cases, property owners may indicate the status of the property such as “Not for Sale,” “Rented Until August,” or (i.e., and/or) “Would Consider Selling,” and this status may be shown to prospective buyers or used to block messaging from buyers.

In some embodiments, a message may be algorithmically evaluated by system 12 to determine whether the message is abusive, e.g., is spam or contains offensive language. For example, purchase amounts in offers may be compared against predicted values for the house, and messages conveying unreasonable offers may be deleted or down ranked when presenting messages to property owners by the system 12. For example, an offer for less than 50% of the predicted value of a property may cause that offer to be deleted or down ranked. Similarly, unreasonably high offers may also be deleted, such as an offer for more than 10 times the predicted value of the property. Further, when messages are presented to property owners, the property owner may be afforded an opportunity (e.g., presented an interface by which to effect the specified action) to designate a message as abusive or blatantly unreasonable. Some embodiments of system 12 may also search the text of messages for keywords that are offensive and, in response to finding such an offensive word, delete the message. In some cases, amounts of deleted messages may be associated with buyer profiles, and buyers with more than a threshold number of such flagged messages may be banned from the system. In some embodiments, buyers may be rate-limited by system 12 in the amount of messages sent in a given duration, e.g., limiting buyers to fewer than 100 messages in a given day to avoid spam. Thus, after receiving a message from a buyer, some embodiments may compare a count of messages over a trailing duration to a threshold and only send the message if the count is less than the threshold.

In some cases, upon a property receiving a message, some embodiments of the property-messaging system 12 may determine whether the property is claimed by an owner and, in response to such a determination, the owner may be sent an email, a text message, or the like to indicate that they should log in to the property-messaging system 12 to view the new message regarding the property. In some cases, upon determining that no owner has claimed the property, in response to such a message, or in response to a threshold amount (like a total quantity, a rate, or the like) of such messages, some embodiments of system 12 may cause a verification postcard, like those described above, to be sent to the corresponding property. (Sending such postcards can be expensive, so targeting the postcards to owners likely to respond due to pending messages is expected to save on postal fees.) In some cases, the printed message may include an indication of the number of messages waiting for the homeowner and, in some cases, indications of the amount that people are willing to pay for the house to entice homeowners to claim the property. (It should be noted that while some embodiments are described with reference to homeowners, embodiments are not limited to residential property and are applicable to, for example, commercial properties as well.)

Upon the homeowner logging in to the property-messaging system, the homeowner may see a list of messages for their property or properties. In some cases, a number of messages may have accumulated before the homeowner claims the property. Thus, homeowners, in some cases, have a relatively rewarding initial experience with the messaging system, in which they are immediately receiving messages about their property, e.g., during their first logged-in session.

In some embodiments, property owners may be afforded the opportunity, for example via a corresponding graphical user interface presented via one of the user devices 14 according to instructions sent by the property-messaging system 12, to respond to a message from a given buyer. In some embodiments, messages may be stored in and presented as threads, with a plurality of messages presented in chronological order and a given thread being defined by the initial message and responses and responses back to those responses.

Some embodiments of system 12 may define a mailing-address electronic messaging address namespace according to the physical mailing addresses of the properties in the property-messaging system, such that messages may be sent to a given property without logging into the property-messaging system 12. Such addresses, in some embodiments, may follow a predefined format such as street number_Street name_city_state@property-messaging.com. Embodiments may host an email server responsive to such addresses, adding emails to the message for the corresponding property. In other embodiments, the electronic messaging addresses may remain concealed within the property-messaging system 12 to facilitate control of abusive messages and avoid programmatic spamming.

Some embodiments may maintain relatively rich user profiles based on past user behavior. For example, some embodiments of system 12 may maintain a list of properties in which a given user has expressed interest and periodically process that list to infer attributes of the user, such as the types of properties in which the user is likely to be interested in the future. For example, some embodiments may analyze each of the properties in which the user has expressed an interest, for example, by converting a buyers messaging behavior into a vector and clustering the resultant vectors to identify patterns, such as a cluster of messages to single-family homes in high income zip codes with between three and four bedrooms, which may be used to identify properties in the future by system 12 having those attributes and to suggest those properties to the user. Similarly, some embodiments may process messages to which homeowners have responded to profile homeowners and rank or filter messages such that messages the homeowner is likely to respond to are presented with greater visual weight and ranking or are less likely to be filtered out of the system. In some embodiments, such profiles may be used to match homebuyers and property owners, for example, by system 12 determining that a given homebuyer sends the type of message that the property owner tends to respond to and that the property owner's home has the attributes that the given homebuyer tends to seek.

Some embodiments of system 12 may facilitate access to various professionals related to the home buying process for users of the property-messaging system 12. For example, homebuyers may be asked in a user interface (sent by system 12 to device 14 for display, receipt of data, and to return data to system 12) whether they already have a realtor when sending a message and, in response to the user indicating that the answer is no, a realtor may be suggested to the homebuyer. In some cases, realtors may pay for such suggestions, or the homebuyer may be presented with an interface by which the homebuyer puts out a request for bids from realtors. Realtors may pay for placement in such suggestions or may pay for the right to bid on requests for bids put out by homebuyers. Home owners may be presented with a similar interface when viewing messages about their property. In cases where a homeowner is already represented by a realtor, messages relating to the property may be directed to the realtor or to both a realtor and the homeowner, thereby facilitating relatively simple communication between the relevant parties. In some embodiments, realtors may bid for the right to be the endorsed realtor in a given geographic area, and upon a property owner or a prospective buyer requesting a recommendation for a realtor, embodiments may determine the geographic area in which the realtor will be operating, and select the realtor that has paid to be the endorsed service provider in that area. In some embodiments, various other trades and professionals may be selected according to similar techniques, for example contractors, property inspectors, mortgage lenders, movers, and the like. Further, some embodiments may select advertisements to show alongside messages or properties, for example, based on the user profiles and attributes of the property being viewed or the message being viewed, such that relevant ads are shown.

To facilitate the operations described above, some embodiments may maintain various data repositories, such as databases, documents, program state, and the like. As shown, the property-messaging system 12 may include a property data repository 28, a user data repository 26, a message data repository 24, a request for bids data repository 34, a bids data repository 32, an agents data repository 30, and an advertising data repository 36. Examples of the types of data stored therein are described below.

In some embodiments, the property data repository 28 includes a plurality of property records, each property record including a unique property identifier, a messaging address (for example, in the email-like format described above), listing attributes (like whether the property is listed in the multiple listing service, the multiple listing service listing identifier, and an identifier of the realtor), an address (like a mailing address) of the property, a geolocation of the property (for example, a latitude and longitude or bounding polygon with vertices described by latitude and longitude coordinates), attributes of the property (like size, room count, bathroom count, whether it has a garage, a school district identifier, an indication of whether the property is single-family or multifamily, and the like), a record of the current owner (like a user identifier, an indication of whether the owner has been verified as the owner, the date the owner became the owner, and identifiers of messages to the current owner, such as messages sent subsequent to the date the property became owned by the current owner), a list of past owners, and frequently asked questions and answers regarding the property provided by the current owner. In some cases, owner may grow weary of answering the same question from each of the prospective buyers, so owners may be afforded the opportunity to submit a list of frequently asked questions and the answers to those questions, both of which may be presented to buyers when viewing the property. Property records may further include past sale prices, dates upon which the sales occurred.

In some embodiments, the user data repository 26 may include a plurality of user records, each user record including a unique user identifier, a user name, a password, contact information for the user (like an email address, a phone number, and a mailing address), an indication of whether the user has registered with the system, a list of property identifiers that the user has designated as favorites, a list of message identifiers of messages sent by the user, message filtering controls selected by the user (like whether the user has requested to block all messages, whether the user has white listed users from whom they will receive messages or blacklisted users from whom they refuse to receive messages, or various filters relating to other attributes of the messages, such as a request to only see messages with offers in a particular price range), properties owned by the user (such as a list of property IDs corresponding to records in repository 28), and a profile of the user (such as patterns in, or attributes of, properties owned by the user, properties message by the user, offers made by the user, messages to which the user responded, and a user-composed profile, for example, including photos, a bio, and a description of property sought by the user, which may be referenced in messages from the user).

In some embodiments, the message data repository 24 may include a plurality of message records, each message record corresponding to a given message and including a unique message identifier, a user identifier of the user who sent the message, a property identifier of the property to which the message is directed (which in some cases serves as the electronic address of the message), an indication of whether the message was read, an identifier of a thread to which the message belongs, a date the message was sent, a date the message was read, a subject of the message, a body of the message, various selections from predetermined message options like those discussed above, an indication of whether the message was flagged as abusive, and attributes of an offer, such as a price, an indication of whether the offer is contingent on the sale of another property, an indication of whether the offer would be paid in cash, an indication of whether the offer is conditional on repairs or is as-is, and an indication of whether the buyer is prequalified for the offer amount.

The request for bids data repository 32 may include a plurality of request for bids records, each record corresponding to a given buyer or seller requesting bids from a given category of professionals on a given task (like selling or buying a house, moving from one place to another, or financing a transaction). In some embodiments, each such record includes a unique request for bid identifier, a description of the transaction (like an identifier of the property and an identifier of the user submitting the request for bid), a list of bids that have been submitted, a start time for bidding, and end time for bidding, and an identifier of a winner if such a winner has been selected.

In some embodiments, the bid data repository 32 may include a plurality of bid records, each bid record representing a given submission for a given one of the request for bids by a professional. In some embodiments, each such record may include a unique bid identifier, an identifier of the professional, and terms of the bid, like a percentage of the purchase price that will be taken by the professional, a price for services, or the like. These bids may be presented to the user requesting bids at the time bidding ends (or before, e.g., as they arrive).

In some embodiments, the agent data repository 32 may include a plurality of agent records, each agent record corresponding to a given one of the above-described professionals. In some embodiments, each such record may include a unique agent identifier, an agent password for the system, an agent username for the system, an agent type (for example, whether the agent is a real estate agent, a mortgage broker, a mover, a home inspector, or the like), geographic areas served by the agent, a multiple listing service identifier of the agent, contact information of the agent, a subscription cost for the agent, a payment status for the agent, a subscription expiration date for the agent, and claimed geographic areas, such as a list of zip codes the agent has purchased as areas in which to be endorsed by the system and beginning and ending dates for those endorsement periods. In some cases, agents may subscribe to the system to receive leads or for the right to present ads or bid on requests for bids. Such subscriptions may be verified by an agent submitting credentials to log into the system, and those credentials may be compared to known credentials in the agent record, along with a subscription status. Upon system 12 determining that the credentials match, and the subscription status is active, certain features may be activated for the respective user. Some embodiments may allow people to use usernames rather than their real name to help protect their identity, although they can, in some implementations, choose to have their identity verified (even if that identity is not shared) to give them more credibility, and verification status may be displayed in user interfaces adjacent information about the agent.

In some embodiments, the advertising data repository 36 may include a plurality of advertising records, each advertising record including creatives (for instance, photographs, prose description, links, or references to such content by which advertisements are displayed), geographic locations to which the advertisement is to be targeted, attributes of properties to which the advertisement is to be targeted, and attributes of users to which the advertisement is to be targeted. Some embodiments may select among these ads when sending the various interfaces described here to show relevant ads to users.

In addition to the above-described data repositories, the property-messaging system may include a number of modules that affect the operations described herein by cooperating with either a native mobile application executing on a user device 14 or a web browser executing on a user device 14 via the Internet 16. In some embodiments, the property-messaging system 12 includes a controller 18 that coordinates the server-side of the various activities described herein, including retrieving data from and writing data to the various data repositories and directing the activities of the various modules of the property-messaging system 12. In some embodiments, the property-messaging system includes an application program interface server 20 that interfaces with a native mobile application executing on the user devices 14 and, in some cases, third parties that syndicate content from the property-messaging system, as well as a webserver 22 that dynamically composes webpages to present the interfaces described herein to solicit the information from users described herein and to present the information to users described herein.

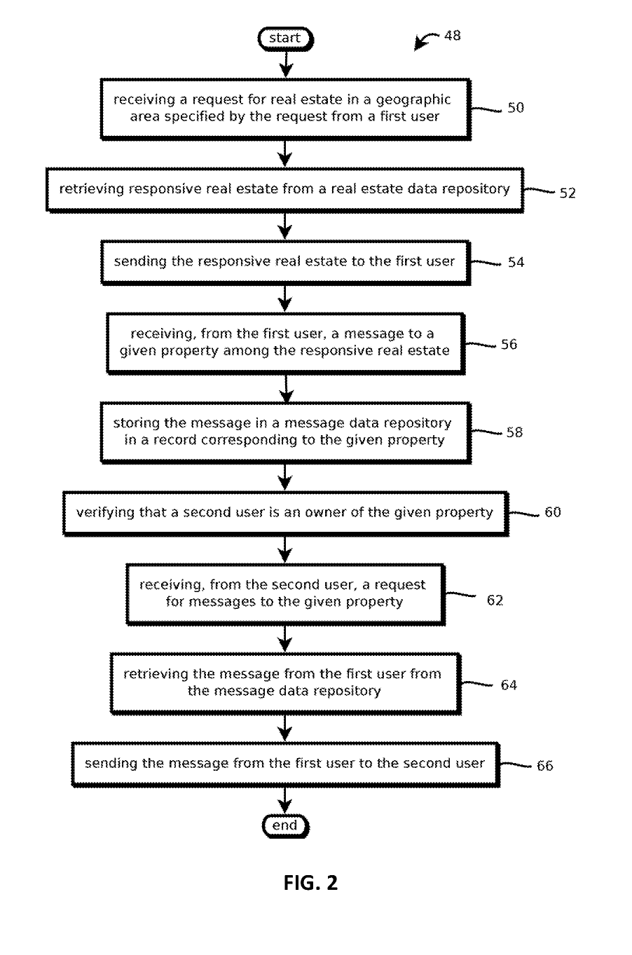

FIG. 2 shows an example of a messaging process 48 that may be performed by the above-described property-messaging system 12. In some embodiments, the process 48 includes receiving a request for real estate in a geographic area specified by the request from a first user, as shown in block 50. Next, the process 48 may include retrieving responsive real estate from a real estate data repository, as shown in block 52, and sending the responsive real estate to the first user, as shown in block 54. Some embodiments may further include receiving, from the first user, a message to a given property among the responsive real estate, as shown in block 56, and storing the message in a message data repository in a record corresponding to the given property, as shown in block 58. Some embodiments may further include verifying that a second user is an owner of the given property, as shown in block 60, and receiving, from the second user, a request for messages to the given property, as shown in block 62. Some embodiments may then retrieve the message from the first user from the message data repository, as shown in block 64, and send the message from the first user to the second user, thereby allowing to users to communicate with one another merely in virtue of the first user being able to identify the property, as shown in block 66.

Thus, some embodiments may facilitate messaging between home owners and interested parties, even when those home owners have not yet registered with the system 12, and when the message sender does not otherwise have contact information for the home owner.

FIG. 3 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices).

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. The term “each” does not mean “each and every,” unless otherwise indicated. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The present techniques will be better understood with reference to the following enumerated embodiments:
1. A method, comprising: receiving a request for real estate in a geographic area specified by the request from a first user; retrieving responsive real estate from a real estate data repository; sending the responsive real estate to the first user; receiving, from the first user, a message to a given property among the responsive real estate; storing the message in a message data repository in a record corresponding to the given property; verifying that a second user is an owner of the given property; receiving, from the second user, a request for messages to the given property; retrieving the message from the first user from the message data repository; and sending the message from the first user to the second user.
2. The method of embodiment 1, wherein verifying that the second user is an owner of the given property comprises: printing a parcel with a unique code and an address of the given property and instructions to log into a website and enter the code to verify the ownership; mailing the parcel to the given property; receiving, via the Internet, the code from the second user; and updating a record for the given property to indicate that the second user is verified as the owner of the given property.
3. The method of any of embodiments 1-2, wherein the message indicates an interest in the property should the property become available for sale or includes a request for an amount the first user is willing to pay to purchase the given property, and wherein the given property is not yet listed by a real estate agent.
4. The method of any of embodiments 1-3, comprising: receiving another message from the second user to the first user; storing the second message in the message data repository; receiving a request from the first user for messages; and sending the other message to the first user.
5. The method of any of embodiments 1-4, wherein the message is received before verifying that the second user is the owner of the given property.
6. The method of any of embodiments 1-5, wherein a unique identifier of the given property is used to as an electronic address in an electronic messaging system through which the message is conveyed.
7. The method of any of embodiments 1-6, comprising: receiving a request for assistance identifying an agent from a third user; sending data describing the request to a plurality of candidate agents; receiving from at least some of the plurality of candidate agents bids to serve as the agent for the third user; and sending at least some of the received bids to the third user.
8. The method of any of embodiments 1-7, comprising: receiving a request for assistance identifying an agent from a third user; determining a geographic area in which the third user will use the agent; retrieving from an agent data repository a candidate agent designated as the endorsed agent for the geographic area; determining that the candidate agent has paid for the endorsement; and sending information identifying the candidate agent to the third user.
9. The method of any of embodiments 1-8, comprising: selecting an advertisement based on the message or the given property; and sending the advertisement to the first user or the second user.
10. The method of any of embodiments 1-9, wherein sending the message from the first user to the second user comprises sending a link to a profile of the first user to the second user.
11. The method of any of embodiments 1-10, wherein retrieving responsive real estate from the real estate data repository comprises: searching both unlisted and listed properties.
10. A tangible, non-transitory, machine-readable medium storing instructions that when executed by a data processing apparatus cause the data processing apparatus to perform operations comprising: the method of any of embodiments 1-11.
11. A system, comprising: one or more processors; and memory storing instructions that when executed by the processors cause the processors to effectuate operations comprising: the method of any of embodiments 1-11.

What is claimed is:

1. A method, comprising:
receiving a request for real estate in a geographic area specified by the request from a first user;
retrieving responsive real estate from a real estate data repository;
sending the responsive real estate to the first user;
receiving, from the first user, a message to a given property among the responsive real estate;
storing the message in a message data repository in a record corresponding to the given property;
verifying that a second user is an owner of the given property, wherein verifying that the second user is an owner of the given property comprises:
printing a parcel with a unique code and an address of the given property and instructions to log into a website and enter the code to verify the ownership;
mailing the parcel to the given property;
receiving, via the Internet, the code from the second user; and
updating a record for the given property to indicate that the second user is verified as the owner of the given property;
receiving, from the second user, a request for messages to the given property;
retrieving the message from the first user from the message data repository; and
sending the message from the first user to the second user.

2. The method of claim 1, wherein the parcel comprises an automatically printed postcard.

3. The method of claim 1, wherein the message indicates an interest in the property should the property become available for sale or includes a request for an amount the first user is willing to pay to purchase the given property, and wherein the given property is not yet listed by a real estate agent.

4. The method of claim 1, comprising:
receiving another message from the second user to the first user;
storing the second message in the message data repository;
receiving a request from the first user for messages; and
sending the other message to the first user.

5. The method of claim 1, wherein the message is received before verifying that the second user is the owner of the given property.

6. The method of claim 1, wherein a unique identifier of the given property is used to as an electronic address in an electronic messaging system through which the message is conveyed.

7. The method of claim 1, comprising:
receiving a request for assistance identifying an agent from a third user;
sending data describing the request to a plurality of candidate agents;
receiving from at least some of the plurality of candidate agents bids to serve as the agent for the third user; and
sending at least some of the received bids to the third user.

8. The method of claim 1, comprising:
receiving a request for assistance identifying an agent from a third user;
determining a geographic area in which the third user will use the agent;
retrieving from an agent data repository a candidate agent designated as the endorsed agent for the geographic area;
determining that the candidate agent has paid for the endorsement; and
sending information identifying the candidate agent to the third user.

9. The method of claim 1, comprising:
selecting an advertisement based on the message or the given property; and
sending the advertisement to the first user or the second user.

10. The method of claim 1, wherein sending the message from the first user to the second user comprises sending a link to a profile of the first user to the second user.

11. The method of claim 1, wherein retrieving responsive real estate from the real estate data repository comprises:
searching both unlisted and listed properties.

12. A system, comprising:
one or more processors; and
memory storing instructions that when executed by the processors cause the processors to effectuate operations comprising:
receiving a request for real estate in a geographic area specified by the request from a first user;
retrieving responsive real estate from a real estate data repository;
sending the responsive real estate to the first user;
receiving, from the first user, a message to a given property among the responsive real estate;
storing the message in a message data repository in a record corresponding to the given property;
verifying that a second user is an owner of the given property, wherein verifying that the second user is an owner of the given property comprises:
printing a parcel with a unique code and an address of the given property and instructions to log into a website and enter the code to verify the ownership;
mailing the parcel to the given property;
receiving, via the Internet, the code from the second user; and
updating a record for the given property to indicate that the second user is verified as the owner of the given property;
receiving, from the second user, a request for messages to the given property;
retrieving the message from the first user from the message data repository; and
sending the message from the first user to the second user.

13. The system of claim 12, wherein the parcel comprises an automatically printed postcard.

14. The system of claim 12, wherein the message indicates an interest in the property should the property become available for sale or includes a request for an amount the first user is willing to pay to purchase the given property, and wherein the given property is not yet listed by a real estate agent.

15. The system of claim 12, comprising:
receiving another message from the second user to the first user;
storing the second message in the message data repository;
receiving a request from the first user for messages; and
sending the other message to the first user.

16. The system of claim 12, wherein the message is received before verifying that the second user is the owner of the given property.

17. The system of claim 12, wherein a unique identifier of the given property is used to as an electronic address in an electronic messaging system through which the message is conveyed.

18. The system of claim 12, comprising:
receiving a request for assistance identifying an agent from a third user;
sending data describing the request to a plurality of candidate agents;
receiving from at least some of the plurality of candidate agents bids to serve as the agent for the third user; and
sending at least some of the received bids to the third user.

19. The system of claim 12, comprising:
receiving a request for assistance identifying an agent from a third user;
determining a geographic area in which the third user will use the agent;
retrieving from an agent data repository a candidate agent designated as the endorsed agent for the geographic area;
determining that the candidate agent has paid for the endorsement; and
sending information identifying the candidate agent to the third user.

20. The system of claim 12, comprising:
selecting an advertisement based on the message or the given property; and
sending the advertisement to the first user or the second user.

21. The system of claim 12, wherein sending the message from the first user to the second user comprises sending a link to a profile of the first user to the second user.

22. The system of claim 12, wherein retrieving responsive real estate from the real estate data repository comprises:
searching both unlisted and listed properties.

23. A tangible, non-transitory, machine-readable medium storing instructions that when executed by a data processing apparatus cause the data processing apparatus to perform operations comprising:
retrieving responsive real estate from a real estate data repository;
sending the responsive real estate to the first user;
receiving, from the first user, a message to a given property among the responsive real estate;
storing the message in a message data repository in a record corresponding to the given property;
verifying that a second user is an owner of the given property, wherein verifying that the second user is an owner of the given property comprises:
printing a parcel with a unique code and an address of the given property and instructions to log into a website and enter the code to verify the ownership;
mailing the parcel to the given property;
receiving, via the Internet, the code from the second user; and
updating a record for the given property to indicate that the second user is verified as the owner of the given property;
receiving, from the second user, a request for messages to the given property;
retrieving the message from the first user from the message data repository; and
sending the message from the first user to the second user.
